(19) United States
(12) Patent Application Publication
(10) Pub. No.: US 2006/0164339 A1
(43) Pub. Date: Jul. 27, 2006

(54) PLASMA DISPLAY APPARATUS AND DRIVING METHOD THEREOF

(75) Inventor: Young Dae KIM, Haewundae-gu (KR)

Correspondence Address: FISH & RICHARDSON P.C., P.O. BOX 1022, MINNEAPOLIS, MN, 55440-1022, US

(73) Assignee: LG Electronics Inc., Youngdungpo-gu (KR)

(21) Appl. No.: 11/275,678

(22) Filed: Jan. 24, 2006

(30) Foreign Application Priority Data
Jan. 25, 2005 (KR) 10-2005-0006878

(51) Int. Cl. G09G 3/28

(52) U.S. Cl. 345/67

(57) ABSTRACT

A plasma display apparatus and a driving method thereof are provided. The plasma display apparatus includes a plasma display panel and a timing controller. The plasma display panel is driven by dividing each of a plurality of subfields into a reset period, an address period and a sustain period. A subfield including a reset period, or the reset period and an address period, or the reset period, the address period and a sustain period is included between adjacent two subfields of the plurality of subfields.

This Nonprovisional application claims priority under 35 U.S.C. § 119(a) on Patent Application No. 10-2005-0006878 filed in Korea on Jan. 25, 2005 the entire contents of which are hereby incorporated by reference.

### BACKGROUND OF THE INVENTION

1. Field of the Invention

The present invention relates to a display apparatus, and more particularly, to a plasma display apparatus and a driving method thereof.

2. Description of the Background Art

With development of information society, recently, display apparatuses have been significantly considered as visual information media. A cathode ray tube mainly used as the display apparatuses is heavy in weight and bulky. Accordingly, various kinds of flat display apparatus have been developed to overcome the problem of the cathode ray tube.

Examples of the flat display apparatus comprise a liquid crystal display apparatus, a plasma display apparatus, a field emission display apparatus and an electro-luminescence.

Of the flat display apparatus, the plasma display apparatus comprises a plasma display panel and a driver for driving the plasma display panel. Ultraviolet rays of 147 nm emitted by discharging a He—Xe gas mixture, a Ne—Xe gas mixture or a He—Xe—Ne gas mixture injected inside the plasma display panel emits phosphors. As a result, images and moving images including characters or graphics are displayed on the plasma display panel. It is easy to manufacture the thin film and large-sized plasma display apparatus. Moreover, recently, the image quality of the plasma display apparatus is greatly improved with the technology development thereof.

In particular, a three-electrode surface-discharge type AC plasma display apparatus accumulates wall charges generated by a discharge using a dielectric layer to lower a voltage required for the discharge. Since the dielectric layer protects electrodes from sputtering of plasma discharge, the three-electrode surface-discharge type AC plasma display apparatus is driven at a low voltage and has long life span.

FIG. 1 is a prospective view of a discharge cell of a related art three-electrode surface-discharge type AC plasma display panel.

Referring to FIG. 1, the discharge cell of the three-electrode surface-discharge type AC plasma display panel comprises a scan electrode Y and a sustain electrode Z formed on a front substrate 10 and an address electrode X formed on a rear substrate 18. The scan electrode Y and the sustain electrode Z each comprise transparent electrodes 12Y and 12Z and metal bus electrodes 13Y and 13Z formed at an edge of one side of each of the transparent electrodes 12Y and 12Z. The metal bus electrodes 13Y and 13Z have line-widths narrower than line-widths of the transparent electrodes 12Y and 12Z.

The transparent electrodes 12Y and 12Z are formed on the front substrate 10 generally using indium-tin-oxide (ITO). The metal bus electrodes 13Y and 13Z are formed on the transparent electrodes 12Y and 12Z using a metal such as chrome (Cr) to reduce a voltage drop of the plasma display panel caused by the transparent electrodes 12Y and 12Z with a high resistance. An upper dielectric layer 14 and a protective layer 16 are stacked on the front substrate 10 on which the scan electrode Y and the sustain electrode Z are formed in parallel with each other. Wall charges generated by a plasma discharge are accumulated on the upper dielectric layer 14. The protective layer 16 prevents damage of the upper dielectric layer 14 from sputtering generated by the plasma discharge and also, increases a secondary electron emission coefficient. The protective layer 16 is generally formed of MgO.

A lower dielectric layer 22 and a barrier rib 24 are formed on the rear substrate 18 on which the address electrode X is formed. A phosphor layer 26 is coated on the surfaces of the lower dielectric layer 22 and the barrier rib 24. The address electrode X is formed to intersect the scan electrode Y and the sustain electrode Z. The barrier rib 24 is formed in parallel with the address electrode X. The barrier rib 24 prevents ultraviolet rays and visible light generated by the plasma discharge from being emitted into adjacent discharge cells. The phosphor layer 26 excites by ultraviolet rays generated by the plasma discharge to emit any one of red, green or blue visible lights. An inert mixture gas is injected into a discharge space between the front and rear substrates 10 and 18 and the barrier rib 24.

FIG. 2 illustrates a method of achieving grey scale of a related art plasma display apparatus. As shown in FIG. 2, the related art plasma display apparatus is driven by dividing one frame into several subfields where number of light-emissions of each subfield is different from one another. Each of the subfields includes a reset period for resetting the whole screen, an address period for selecting a scan line and selecting a cell from the selected scan line and a sustain period for realizing grey scale according to number of discharges.

The reset period includes a set-up period for supplying a rising waveform and a set-down period for supplying a falling waveform. For example, in a case of achieving 256 level grey scale, a frame period (16.67 ms) corresponding to a 1/60 second, as shown in FIG. 2, is divided into eight subfields SF1 to SF8. The eight subfields SF1 to SF8 each include the reset period, the address period and the sustain period. The durations of the reset period and the address period are the same for each of the subfields. The sustain period increases in a ratio of 2ⁿ (n=0, 1, 2, 3, 4, 5, 6, 7) for each of the subfields.

FIG. 3 illustrates a driving method of a related art plasma display apparatus.

As shown in FIG. 3, the related art plasma display apparatus is driven by dividing each of a plurality of subfields into a reset period for resetting the whole screen, an address period for selecting cells to be discharged and a sustain period for maintaining discharges of the selected cells.

In the reset period, a rising waveform Ramp-up is simultaneously applied to all of scan electrodes Y during a set-up period. A voltage of the scan electrode Y increases up to a voltage Vp for discharging the cells. A weak dark discharge is generated within the cells of the whole screen by applying the rising waveform Ramp-up to produce wall charges within the cell. In a set-down period, after the rising waveform Ramp-up is supplied during the setup period, a falling waveform Ramp-down which falls from a positive voltage lower than a peak voltage of the rising waveform Ramp-up is simultaneously applied to the scan electrode Y. The falling waveform Ramp-down generates a weak erase discharge within the cells to remove unnecessary charges of the wall charges and space charges produced by the set-up discharge. Moreover, wall charges required for an address discharge uniformly remains within the cells of the whole screen.

In the address period, a negative scan pulse Sp is sequentially applied to the scan electrodes Y and, at the same time, a positive data pulse Dp is applied to address electrodes X. While the difference between a voltage Vy of the negative scan pulse Sp and a voltage Va of the positive data pulse Dp is added to the wall charges produced during the reset period, an address discharge is generated within the cells to which the data pulse Dp is applied. Wall charges are produced within the cells selected by the address discharge.

A positive DC voltage having a magnitude of a sustain voltage Vs is applied to sustain electrodes Z during the set-down period and the address period.

In the sustain period, a sustain pulse SUSp having the magnitude of the sustain voltage Vs is alternately supplied to the scan electrode Y and the sustain electrode Z. While the wall voltage within the cells selected by the address discharge is added to the sustain pulse SUSp, a sustain discharge is generated between the scan electrode Y and the sustain electrode Z whenever the sustain pulse SUSp is applied. Finally, after completing the sustain discharge, an erase waveform ERSp having a narrow pulse width is supplied to the sustain electrode Z to remove the wall charges within the cell.

When a power supply of the plasma display apparatus is turned on, an initial waveform is applied to the scan, address and sustain electrodes to obtain time required for increasing the plurality of voltages, for example, Vp, Vs, Vy and Va up to a desired voltage value.

FIG. 4 illustrates an initial waveform of a related art plasma display apparatus.

Referring to FIG. 4, after the supply of a power supply of the plasma display apparatus, the initial waveform of the related art plasma display apparatus is applied to the plasma display apparatus. In the initial waveform, a data pulse is not supplied to all of address electrodes X during an address period not to generate a discharge. A scan pulse and a sustain pulse applied during a reset period and a sustain period is the same as those supplied to a general plasma display apparatus.

However, there is a problem in that a residual image is displayed on a plasma display panel of the related art plasma display apparatus by the generation of a undesired sustain discharge during the supply of the initial waveform.

Since users turn off the power supply of the plasma display apparatus if they want to, wall charges remains within discharge cells displayed when the users turn off the power supply of the plasma display apparatus. In particular, most of the wall charges remain within the discharge cell with the high brightness prior to the cut-off of the power supply of the plasma display apparatus. The undesired sustain discharge is generated during the sustain period of the initial waveform by the remained wall charges.

### SUMMARY OF THE INVENTION

Accordingly, an object of the present invention is to solve at least the problems and disadvantages of the background art.

The present invention provides a plasma display apparatus capable of preventing a residual image on a screen and a driving method thereof.

According to an aspect of the present invention, there is provided a plasma display apparatus comprising a plasma display panel including a scan electrode and a sustain electrode, and a timing controller for applying one or more erase pulses to at least one of the scan electrode and the sustain electrode after a power-off signal receives.

According to another aspect of the present invention, there is provided a plasma display apparatus comprising a plasma display panel which is driven by dividing each of a plurality of subfields into a reset period, an address period and a sustain period and a timing controller, a subfield which includes a reset period, or the reset period and an address period, or the reset period, the address period and a sustain period being included between adjacent two subfields of the plurality of subfields.

According to still another aspect of the present invention, there is provided a driving method of a plasma display apparatus comprising dividing each of a plurality of subfields into a reset period, an address period and a sustain period, and arranging a subfield which includes a reset period, or the reset period and an address period, or the reset period, the address period and a sustain period between adjacent two subfields of the plurality of subfields.

The present invention prevents a residual image displayed on a screen when a power supply of the plasma display apparatus is turned on again after turning off the power supply thereof.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention. In the drawings:

FIG. 1 is a prospective view of a discharge cell of a related art three-electrode surface-discharge type AC plasma display panel;

FIG. 2 illustrates a method of achieving grey scale of a related art plasma display apparatus;

FIG. 3 illustrates a driving method of a related art plasma display apparatus;

FIG. 4 illustrates an initial waveform of a related art plasma display apparatus;

FIG. 5 schematically shows a structure of a plasma display apparatus according to a first embodiment of the present invention;

FIG. 6 shows a driving waveform for explaining a driving method of the plasma display apparatus according to the first embodiment of the present invention;

FIG. 7 shows an erase pulse applied on driving the plasma display apparatus according to the first embodiment of the present invention; and

FIGS. 8a and 8b illustrate a driving method of a plasma display apparatus according to a second embodiment of the present invention.

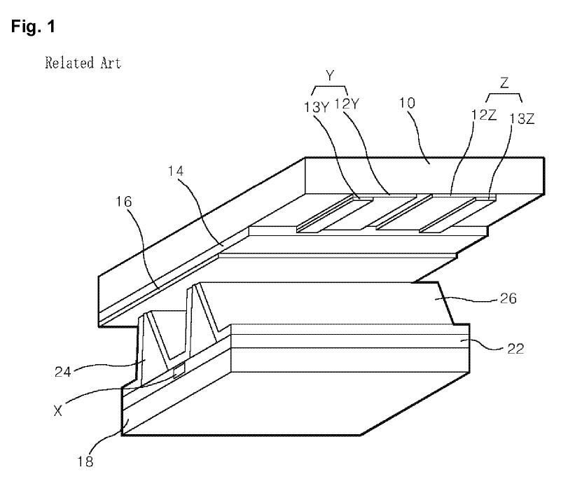

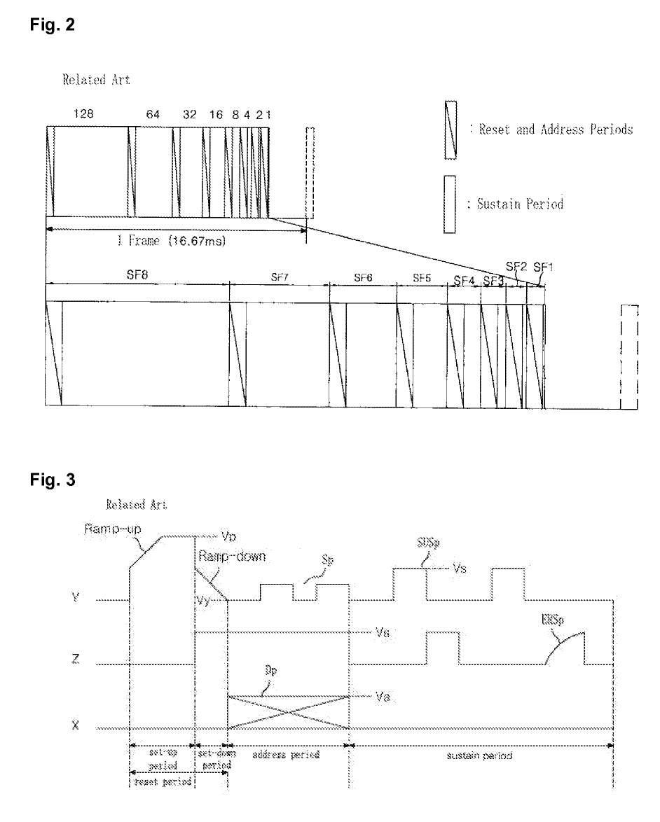

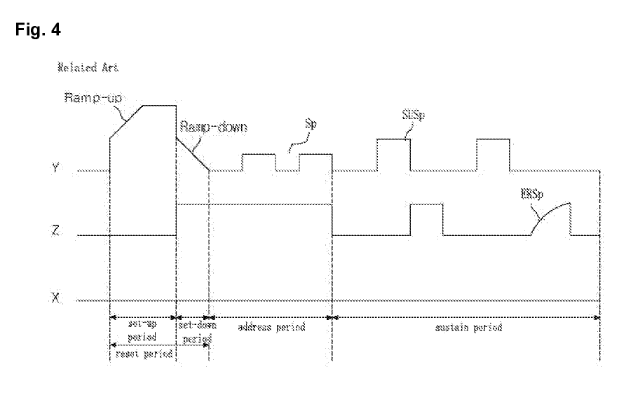

### DETAILED DESCRIPTION OF PREFERRED EMBODIMENTS

Reference will now be made in detail to embodiments of the present invention, examples of which are illustrated in the accompanying drawings.

A plasma display apparatus according to an embodiment of the present invention comprises a plasma display panel comprising a scan electrode and a sustain electrode, and a timing controller for applying one or more erase pulses to at least one of the scan electrode and the sustain electrode after a power-off signal receives.

The erase pulse is a pulse with a slope.

A maximum value voltage of the erase pulse is substantially the same as a voltage of a sustain pulse applied to the scan electrode or the sustain electrode.

A width of the erase pulses is narrower than a width of the sustain pulse applied to the scan electrode or the sustain electrode.

The number of erase pulses ranges from 1 to 10.

A plasma display apparatus according to another embodiment of the present invention comprises a plasma display panel which is driven by dividing each of a plurality of subfields into a reset period, an address period and a sustain period and a timing controller, a subfield which includes a reset period, or the reset period and an address period, or the reset period, the address period and a sustain period being included between adjacent two subfields of the plurality of subfields.

A data pulse is applied to all of address electrodes of the plasma display panel during an address period of a postdated subfield in the adjacent two subfields.

The number of sustain pulses applied to a scan electrode or a sustain electrode of the plasma display panel during a sustain period of the postdated subfield in the adjacent two subfields ranges from 1 to 10.

A driving method of a plasma display apparatus according to still another embodiment of the present invention comprises dividing each of a plurality of subfields into a reset period, an address period and a sustain period, and arranging a subfield which includes a reset period, or the reset period and an address period, or the reset period, the address period and a sustain period between adjacent two subfields of the plurality of subfields.

Hereinafter, exemplary embodiments of the present invention will be described in detail with reference to the attached drawings.

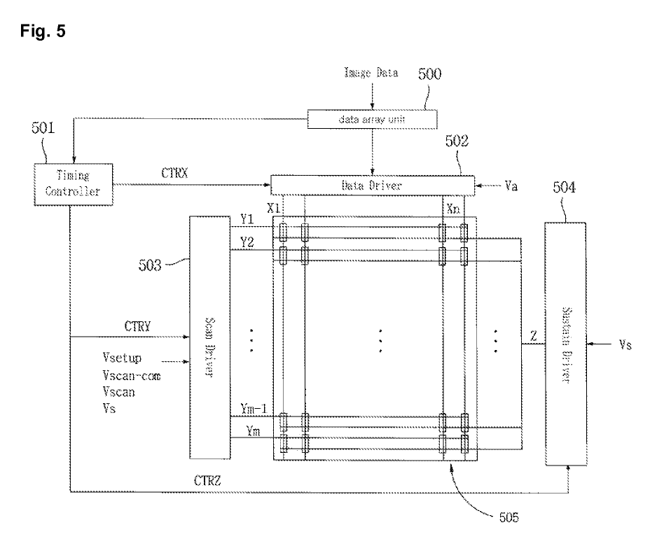

FIG. 5 schematically shows a structure of a plasma display apparatus according to a first embodiment of the present invention.

As shown in FIG. 5, the plasma display apparatus according to the first embodiment of the present invention comprises a plasma display panel 505, a data array unit 500 for arraying image date, a data driver 502 for supplying the arrayed image data to address electrodes X1 to Xm formed on a lower substrate (not shown) of the plasma display panel 505, a scan driver 503 for driving scan electrodes Y1 to Yn, a sustain driver 504 for driving sustain electrodes Z being common electrodes, and a timing controller 501 for controlling the data driver 502, the scan driver 503, the sustain driver 504 when the plasma display panel 505 is driven.

The plasma display apparatus is driven by dividing each of a plurality of subfields into a reset period, an address period and a sustain period.

An upper substrate (not shown) and the lower substrate of the plasma display panel 505 are coupled with each other at a given distance. On the upper substrate, a plurality of electrodes, for example, the scan electrodes Y1 to Yn and the sustain electrodes Z are formed in pairs. On the lower substrate, the address electrodes X1 to Xm are formed to intersect the scan electrodes Y1 to Yn and the sustain electrodes Z.

The data array unit 500 arrays data, which is inverse-gamma corrected and error diffused in an inverse gamma correction circuit (not shown) and an error diffusion circuit (not shown) and then mapped to each of the subfields in a subfield mapping circuit (not shown).

The data driver 502 samples and latches the data in response to a timing control signal CTRX from the timing controller 501 and then supplies the data to the address electrodes X1 to Xm.

The scan driver 503 supplies a reset pulse having a rising waveform and a falling waveform to all of the scan electrodes Y1 to Yn during the reset period. The scan driver 503 sequentially supplies a scan pulse to the scan electrodes Y1 to Yn during the address period. The scan driver 503 supplies a sustain pulse generated by an energy recovery circuit (not shown) installed in the scan driver 503 to the scan electrodes Y1 to Yn during the sustain period. When a power-off signal is input from the outside in any one of the reset period, the address period and the sustain period, the scan driver 503 supplies an erase pulse to the scan electrodes Y1 to Yn during a predetermined period to generate a preliminary discharge. Moreover, under the control of the timing controller 501, the power supply applied to the scan electrodes Y1 to Yn is cut off.

After the input of the power-off signal, the erase pulse uniforms wall charges formed within discharge cells of the plasma display panel. The erase pulse may include various types of pulses. That is, the erase pulse may have a predetermined slope or be a square wave like the sustain pulse.

Moreover, a maximum value voltage of the erase pulse is substantially the same as a voltage of the sustain pulse applied during the sustain period. The reason is to supply the erase pulse and the sustain pulse using the same voltage supply source for a reduction in the manufacturing cost.

The sustain driver 504 supplies a DC voltage Vz to the sustain electrodes Z from a supply period of the falling waveform to the scan electrode during the reset period to the address period. During the sustain period, an energy recovery circuit (not shown) installed in the sustain driver 504 and the energy recovery circuit (not shown) installed in the scan driver 503 are operated alternately to supply the sustain pulse to the sustain electrodes Z. Like the scan driver 503, when the power-off signal is input from the outside in any one of the reset period, the address period and the sustain period, the sustain driver 504 supplies the erase pulse to the sustain electrodes Z during the predetermined period to generate the preliminary discharge. Moreover, under the control of the timing controller 501, the power supply applied to the sustain electrodes Z is cut off.

As described above, when the power-off signal is input, the erase pulse is applied to both the scan electrode and the sustain electrode. However, the erase pulse may be applied to either the scan electrode or the sustain electrode. Further, it is preferable that after the input of the power-off signal, the number of erase pulses applied to at least one of the scan electrode and the sustain electrode is equal to or more than 1 to less than 10. The reason is to minimize the brightness of light caused by the preliminary discharge generated by the erase pulse as possible.

The timing controller 501 receives a vertical/horizontal synchronization signal and a clock signal and generates timing control signals CTRX, CTRY and CTRZ for controlling operation timing and synchronization of each of the drivers 502, 503 and 504 in the reset period, the address period and the sustain period. The timing controller 121 supplies the timing control signals CTRX, CTRY and CTRZ to the corresponding drivers 502, 503 and 504 to control each of the drivers 502, 503 and 504.

The data control signal CTRX includes a sampling clock for sampling data, a latch control signal and a switch control signal for controlling an on/off time of a sustain driving circuit and a driving switch element. The scan control signal CTRY includes a switch control signal for controlling an on/off time of a sustain driving circuit and a driving switch element, which are installed in the scan driver 503. The sustain control signal CTRZ includes a switch control signal for controlling on/off time of a sustain driving circuit and a driving switch element, which are installed in the sustain driver 504.

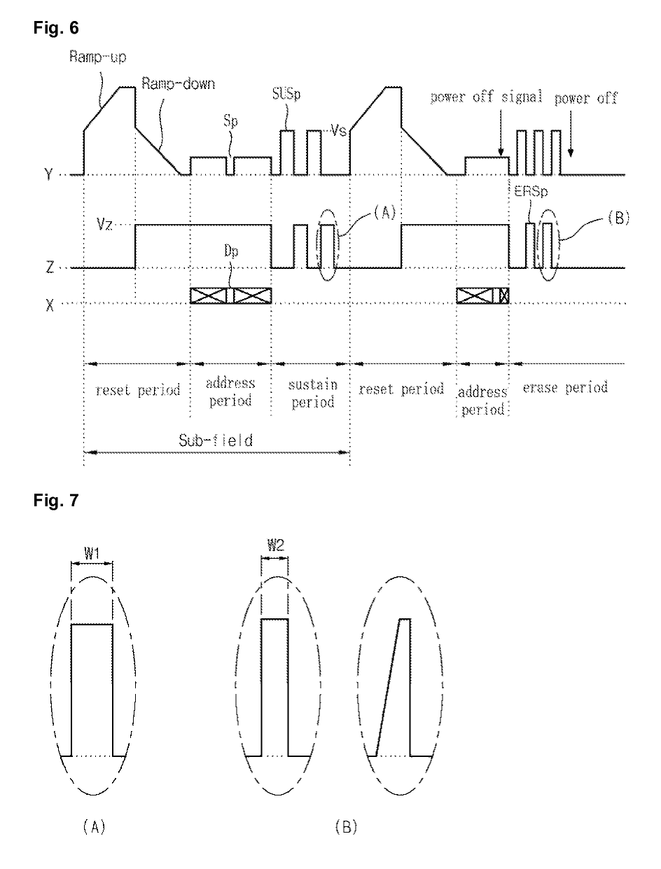

FIG. 6 shows a driving waveform for explaining a driving method of the plasma display apparatus according to the first embodiment of the present invention.

As shown in FIG. 6, when the power-off signal is input to the plasma display apparatus on displaying images on the plasma display panel by the combination of the subfields of the plasma display panel, under the control of the timing controller 501 of FIG. 5, the erase pulse is applied to the scan electrode X or the sustain electrode Z during the predetermined period and then the power supply applied to the scan electrode X or the sustain electrode Z is cut off. Although the power-off signal is input during the address period in FIG. 6, the power-off signal may be input during the reset period or the sustain period.

The erase pulse applied under the control of the timing controller 501 generates a weak discharge in all of the discharge cells of the plasma display panel. The erase pulse, as shown in FIG. 7, may be a square wave, like the sustain pulse applied during the sustain period of the subfield prior to the input of the power-off signal, or a pulse having a slope.

Only, when the erase pulse is the square wave, it is preferable that the erase pulse of the square wave with a width w2 narrower than a width w1 of the sustain pulse applied during the sustain period of the subfield prior to the input of the power-off signal is applied to the scan electrode Y or the sustain electrode Z. The reason is to stably uniform wall charges accumulated on the discharge cells of the plasma display panel.

As described above, since the plasma display panel includes the erase period capable of uniformizing the wall charges prior to the cut-off of the power supply of the plasma display apparatus, when users turn on the power supply of the plasma display apparatus again after turning off the power supply thereof, a residual image displayed on the plasma display panel can be prevented.

A structure of a plasma display apparatus according to a second embodiment of the present invention is the same as the structure of the plasma display apparatus according to the first embodiment of the present invention. Only, in the plasma display apparatus according to the second embodiment of the present invention, when a power-off signal is input from the outside in any one of a reset period, an address period and a sustain period, a timing controller starts to control a new subfield. That is, the timing controller controls data, scan and sustain drivers to uniform wall charges accumulated on discharge cells of a plasma display panel and then cuts off a power supply of the plasma display apparatus.

The new subfield includes a reset period, an address period and a sustain period, like a subfield prior to the input of the power-off signal. Only, while a data pulse is selectively applied to a portion of address electrodes during an address period of the subfield prior to the input of the power-off signal, a data pulse is applied to all of the address electrodes during the address period of the new subfield.

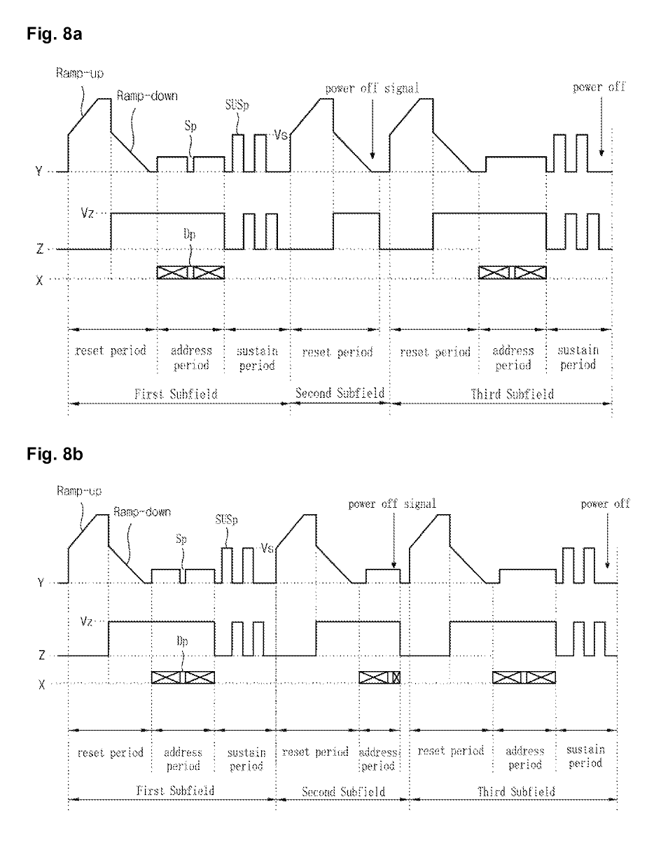

FIGS. 8a and 8b illustrate a driving method of a plasma display apparatus according to a second embodiment of the present invention.

As shown in FIGS. 8a and 8b, when a power-off signal is input to the plasma display apparatus on displaying images on a plasma display panel by the combination of subfields of the plasma display panel, a timing controller (not shown) controls data, scan and sustain drivers (not shown) to supply a predetermined pulse to a scan electrode Y, a sustain electrode Z and an address electrode X during a reset period, an address period and a sustain period and then cuts off a power supply of the plasma display apparatus. The power-off signal may be input during the reset period, as shown in FIG. 8a. Further, the power-off signal may be input during the address period as shown in FIG. 8b.

More particularly, when the power-off signal is input to the plasma display apparatus from the outside, a second subfield next to a first subfield arranged prior to the input of the power-off signal is arranged to supply a predetermined pulse to each of the scan electrode Y, the sustain electrode Z and the address electrode X during a reset period, an address period and a sustain period. However, the second subfield may include the reset period, or the reset period and the address period, or the reset period, the address period and the sustain period. Next, a third subfield including a reset period, an address period and a sustain period is arranged to supply a predetermined pulse to each of the scan electrode Y, the sustain electrode Z and the address electrode X during a reset period, an address period and a sustain period. Afterwards, the input of the signal stops and the power supply is cut off.

In the third subfield, the predetermined pulse applied to the scan electrode Y, the sustain electrode Z and the address electrode X stabilizes wall charges produced within discharge cells of the plasma display panel.

As described, the second subfield may include the reset period, or the reset period and the address period, or the reset period, the address period and the sustain period. Moreover, the duration of the reset period or the address period or the sustain period of the second subfield may be reduced.

The third subfield is the last subfield of a frame of the plasma display panel on driving the plasma display apparatus according to the second embodiment of the present invention.

The predetermined pulse applied to the scan electrode, the sustain electrode and the address electrode during the address period of the third subfield may be substantially the same as the pulse applied to each of the scan electrode, the sustain electrode and the address electrode during the address period of the first subfield. Moreover, the predetermined pulse may include one or more of a reset pulse applied during the reset period, a scan pulse applied during the address period and a sustain pulse applied during the sustain period.

Only, the data pulse may be applied to all of the address electrodes in the third subfield.

Further, the predetermined pulse applied to the scan electrode and the sustain electrode during the sustain period of the third subfield is substantially the same as the pulse applied to each of the scan electrode and the sustain electrode during the sustain period of the first subfield. The number of sustain pulses applied during the sustain period of the third subfield is less than the number of sustain pulses applied during the sustain period of the first subfield. It is preferable that the number of sustain pulses of the third subfield ranges from 1 to 10.

The sustain pulses applied during the sustain period of the third subfield may have a slope.

Further, a width of the sustain pulse applied during the sustain period of the third subfield is different from a width of the sustain pulse applied during the sustain period of the first subfield. Preferably, the width of the sustain pulse applied during the sustain period of the third subfield is narrower than the width of the sustain pulse applied during the sustain period of the first subfield.

As described above, since the plasma display panel includes a preliminary subfield period capable of uniformizing the wall charges produced prior to the cut-off of the power supply of the plasma display apparatus, when users turn on the power supply of the plasma display apparatus again after turning off the power supply thereof, a residual image displayed on the plasma display panel is prevented.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel comprising a scan electrode and a sustain electrode; and
a timing controller for applying one or more erase pulses to at least one of the scan electrode and the sustain electrode after a power-off signal receives.

2. The plasma display apparatus of claim 1, wherein the erase pulse is a pulse with a slope.

3. The plasma display apparatus of claim 1, wherein a maximum value voltage of the erase pulse is substantially the same as a voltage of a sustain pulse applied to the scan electrode or the sustain electrode.

4. The plasma display apparatus of claim 1, wherein a width of the erase pulses is less than a width of the sustain pulse applied to the scan electrode or the sustain electrode.

5. The plasma display apparatus of claim 1, wherein the number of erase pulses ranges from 1 to 10.

6. A method of driving a plasma display apparatus comprising:
applying a waveform generated in a first subfield comprising a reset period, an address period and a sustain period;
applying a waveform generated in a second subfield next to the first subfield, the second subfield comprising a reset period, or the reset period and an address period, or the reset period, the address period and a sustain period; and
applying a waveform generated in a third subfield next to the second subfield, comprising a reset period, an address period and a sustain period.

7. The method of claim 6, wherein after applying the waveform of the third subfield, the application of a signal ends.

8. The method of claim 6, wherein the third subfield is the last subfield.

9. The method of claim 6, further comprising after applying the waveform of the third subfield, cutting off a power supply.

10. The method of claim 6, further comprising applying a data pulse to an address electrode during the address period of the third subfield.

11. The method of claim 6, wherein the second subfield comprises the reset period, or the reset period and the address period, or the reset period, the address period and the sustain period by the power-off signal.

12. The method of claim 6, wherein the duration of the reset period or the address period or the sustain period of the second subfield is reduced.

13. The method of claim 6, wherein the number of sustain pulses applied to a scan electrode or a sustain electrode during the sustain period of the third subfield is equal to or less than 10.

14. The method of claim 6, wherein the number of sustain pulses applied to the scan electrode or the sustain electrode during the sustain period of the first subfield is more than the number of sustain pulses applied to the scan electrode or the sustain electrode during the sustain period of the third subfield.

15. The method of claim 6, wherein a width of the sustain pulse applied to the scan electrode or the sustain electrode during the sustain period of the third subfield is different from a width of the sustain pulse applied to the scan electrode or the sustain electrode during the sustain period of the first subfield.

16. The method of claim 15, wherein the width of the sustain pulse applied to the scan electrode or the sustain electrode during the sustain period of the third subfield is narrower than the width of the sustain pulse applied to the scan electrode or the sustain electrode during the sustain period of the first subfield.

17. A method of driving a plasma display apparatus comprising:
applying a waveform generated in a first subfield comprising a reset period, an address period and a sustain period;
applying a waveform generated in a second subfield next to the first subfield, the second subfield comprising a reset period, or the reset period and an address period, or the reset period, the address period and a sustain period; and
applying a stable waveform next to the second subfield.

18. The method of claim 17, wherein the second subfield comprises the reset period, or the reset period and the address period, or the reset period, the address period and the sustain period by the power-off signal.

19. The method of claim 17, wherein the stable waveform comprises one or more of a reset pulse applied during the reset period, a scan pulse applied during the address period and a sustain pulse applied during the sustain period.

20. The method of claim 17, wherein the duration of the reset period or the address period or the sustain period of the second subfield is reduced.
